(19) United States
(12) Patent Application Publication
(10) Pub. No.: US 2015/0290777 A1
(43) Pub. Date: Oct. 15, 2015

(54) WORK TOOL HAVING FUNCTION PART WITH FRICTION FACE

(71) Applicant: Chiung-Chang Tsai, Taichung (TW)

(72) Inventor: Chiung-Chang Tsai, Taichung (TW)

(21) Appl. No.: 14/253,828

(22) Filed: Apr. 15, 2014

(51) Int. Cl. B25B 7/02; F16B 2/20; B25B 13/58

(52) U.S. Cl. CPC B25B 7/02; B25B 13/58; F16B 2/20

(57) ABSTRACT

A work tool includes a tool body having a function part connected to one end of the tool body. The function part has at least one contact face which has at least one area that has multiple abrasive particles. The abrasive particles are the same as those used for a grinding wheel so as to form a friction surface in the at least one area. By friction surface in the at least one area, the work tool can firmly hold an object.

### BACKGROUND OF THE INVENTION

1. Fields of the Invention

The present invention relates to a work tool, and more particularly, to a work tool having function part with a friction face for being in contact with objects.

2. Descriptions of Related Art

One conventional hand tool as disclosed in U.S. Pat. No. 8,020,473 which discloses a handle with a friction surface so as to increase the friction when the user holds the handle. Even when the hand is attached with grease, the friction surface ensures that the grip is firm. However, the tool cannot ensure that the object is firmly clamped by the hand tool.

The present invention intends to provide a hand tool wherein the function part is equipped with at least one friction face so as to firmly clamp the object and to improve the shortcomings mentioned above.

### SUMMARY OF THE INVENTION

The present invention relates to a work tool which includes a tool body having a function part connected to one end of the work tool. The function part has at least one contact face which has at least one area that has multiple particles. The particles are the same as those used for a grinding wheel so as to form a friction surface in the at least one area. By friction surface in the at least one area, the function part of the work tool can firmly clamp, hold or connect an object.

The primary object of the present invention is to provide a work tool having function part with a friction surface at the function part so as to increase the friction between the function part and the object.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the first embodiment of the work tool of the present invention;

FIG. 2 is a perspective view to show the second embodiment of the work tool of the present invention;

FIG. 3 is a perspective view to show the third embodiment of the work tool of the present invention;

FIG. 4 is a perspective view to show the fourth embodiment of the work tool of the present invention;

FIG. 5 is a perspective view to show the fifth embodiment of the work tool of the present invention;

FIG. 6 is a perspective view to show the sixth embodiment of the work tool of the present invention;

FIG. 7 is a perspective view to show the seventh embodiment of the work tool of the present invention;

FIG. 8 is a perspective view to show the eighth embodiment of the work tool of the present invention;

FIG. 9 is a perspective view to show the ninth embodiment of the work tool of the present invention;

FIG. 10 is a perspective view to show the tenth embodiment of the work tool of the present invention;

FIG. 11 is a perspective view to show the eleventh embodiment of the work tool of the present invention;

FIG. 12 is a perspective view to show the twelfth embodiment of the work tool of the present invention;

FIG. 13 is a perspective view to show the thirteenth embodiment of the work tool of the present invention;

FIG. 14 is a perspective view to show the fourteenth embodiment of the work tool of the present invention;

FIG. 15 is a perspective view to show the fifteenth embodiment of the work tool of the present invention;

FIG. 16 is a perspective view to show the sixteenth embodiment of the work tool of the present invention;

FIG. 17 is a perspective view to show the seventeenth embodiment of the work tool of the present invention;

FIG. 18 is a perspective view to show the eighteenth embodiment of the work tool of the present invention; FIG. 19 is a perspective view to show the nineteenth embodiment of the work tool of the present invention;

FIG. 20 is a perspective view to show the twentieth embodiment of the work tool of the present invention;

FIG. 21 is a perspective view to show the twenty first embodiment of the work tool of the present invention, and

FIG. 22 is a perspective view to show the twenty second embodiment of the work tool of the present invention.

### DETAILED DESCRIPTION OF THE PREFERRED EMBODIMENT

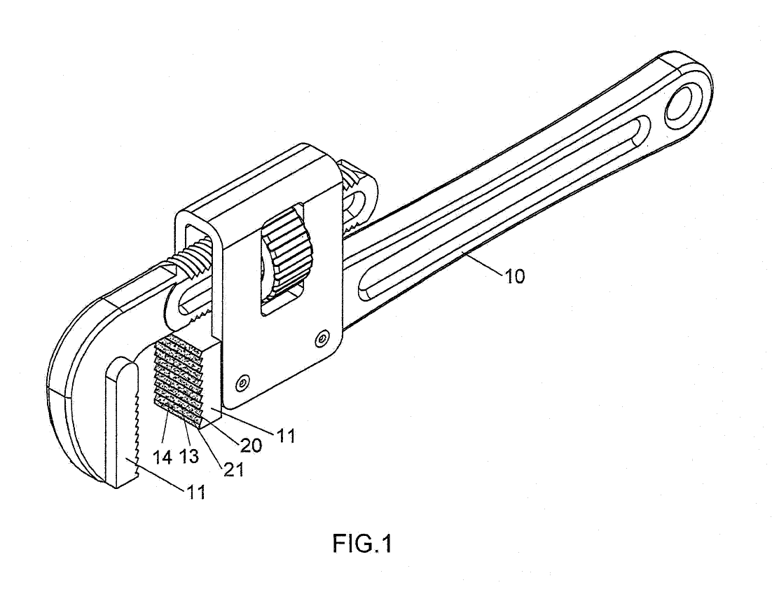

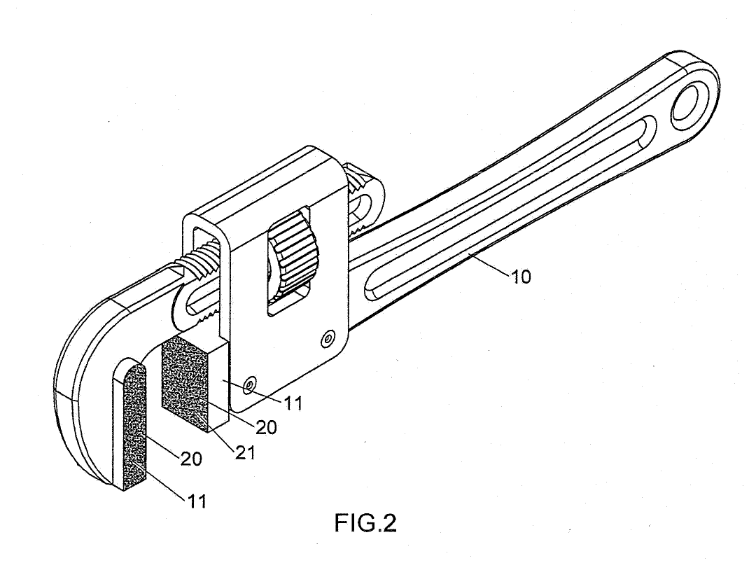

Referring to FIG. 1, the work tool of the present invention comprises a tool body 10 and a function part 11 is connected to at least one end of the tool body 10 so as to clamp an object (such as heads of screws and other kinds of work pieces). The function part 11 has at least one contact face 12 which is in contact with an object. The at least one contact face 12 has at least one area 13 that has multiple abrasive particles 20 which are the same as those for a grinding wheel. The abrasive particles 20 form a friction surface 21 in the at least one area 13 so that the object can be firmly clamped by the work tool even if the object or the work tool is attached with oil or grease. The at least one contact face 12 is fully attached by the abrasive particles 20 as shown in FIG. 1. The abrasive particles 20 can be regular grinding particles and/or ultra-hard grinding particles. The regular grinding particles can be Corundum particles or SiC particles. The ultra-hard grinding particles can be carborundum particles or Boron Nitride (CBN). The abrasive particles 20 are attached to the at least one contact face 12 by way of electro-coating, and the abrasive particles 20 can be fine particles. Alternatively, the abrasive particles 20 are combined with agent and formed onto the at least one contact face 12 by way of sintering. The concentration of the abrasive particles 20 on the at least one contact face 12 is at least 20% g/cm³. Preferably, the concentration of the abrasive particles 20 on the at least one contact face 12 is at least 50% g/cm³.

As shown in FIG. 1, the at least one contact face 12 has multiple teeth 14 and the friction surface 21 is formed on each of the teeth 14. As shown in FIG. 2, the at least one contact face 12 is a plane surface.

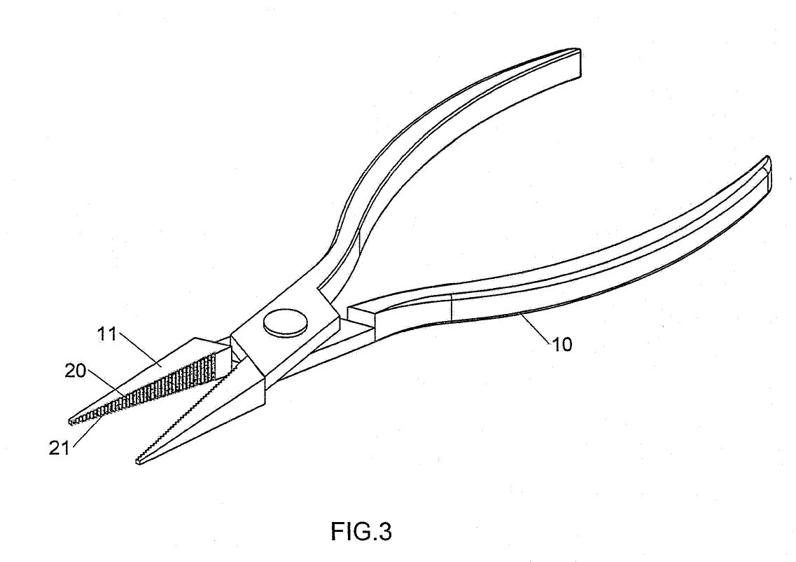

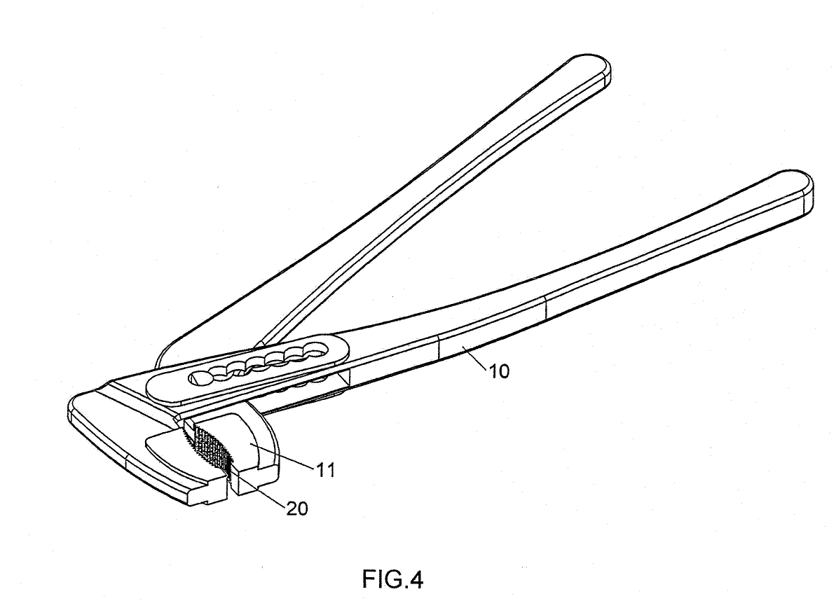

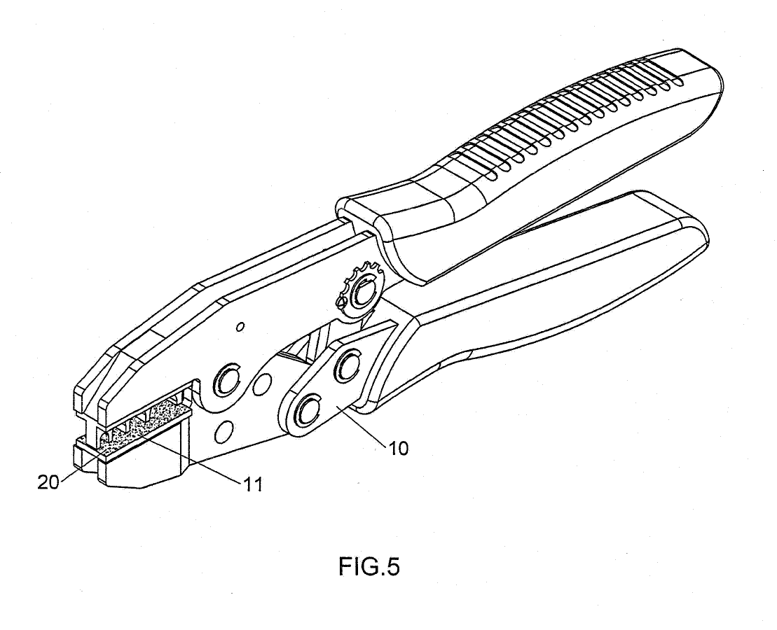

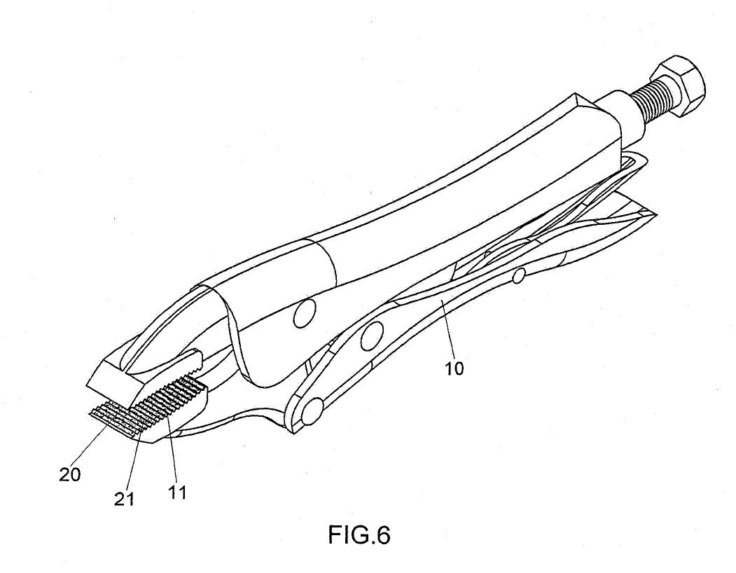

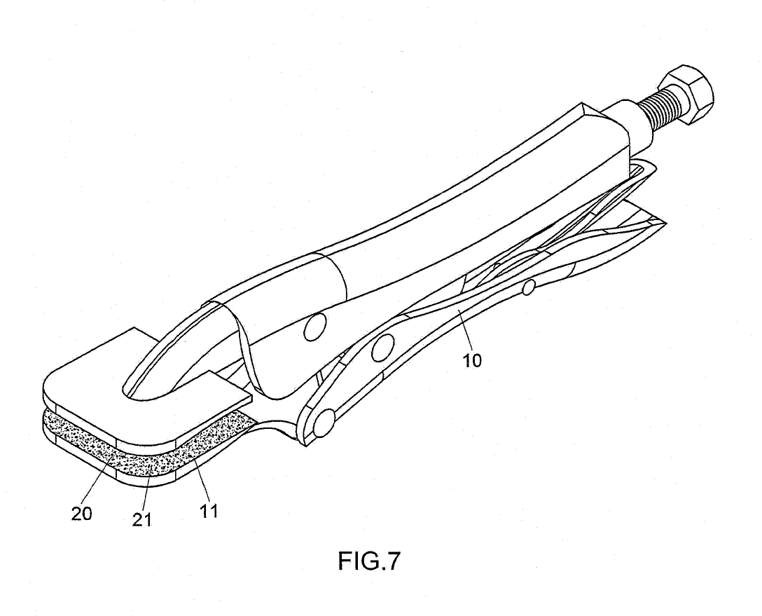

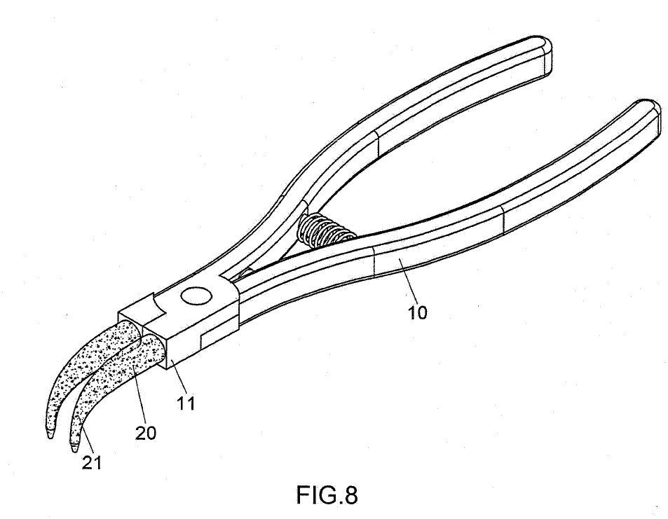

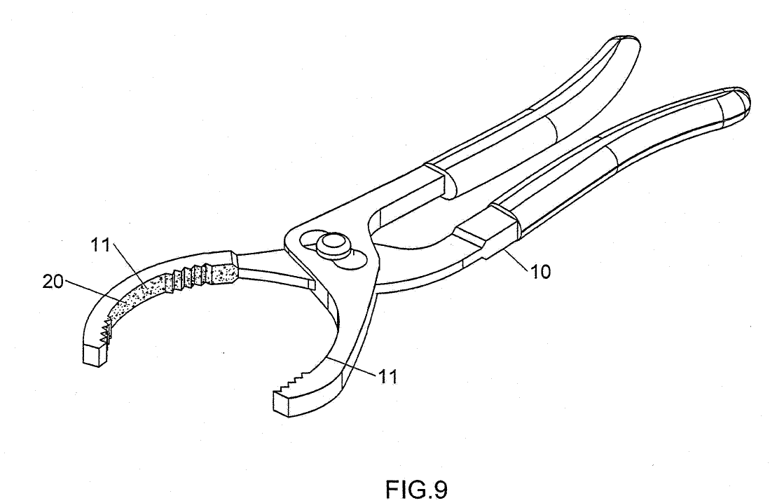

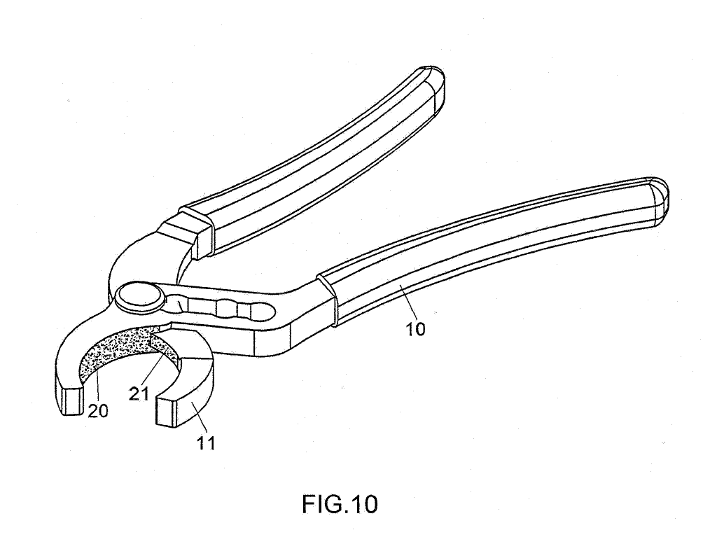

FIGS. 3 to 22 show other embodiments that are equipped with the abrasive particles 20 on the contact face 12. FIG. 3 shows the work tool 10 is the long-nose pliers, FIG. 4 shows the work tool 10 is the tongue and groove pliers, FIG. 5 shows the work tool 10 is the wire pitch-off pliers, FIGS. 6 and 7 respectively show two types of the work tool 10 are the locking pliers, FIGS. 8 shows the work tool 10 is the long and bent nose pliers, FIGS. 9 and 10 show two different types of the work tool 10 are pliers,

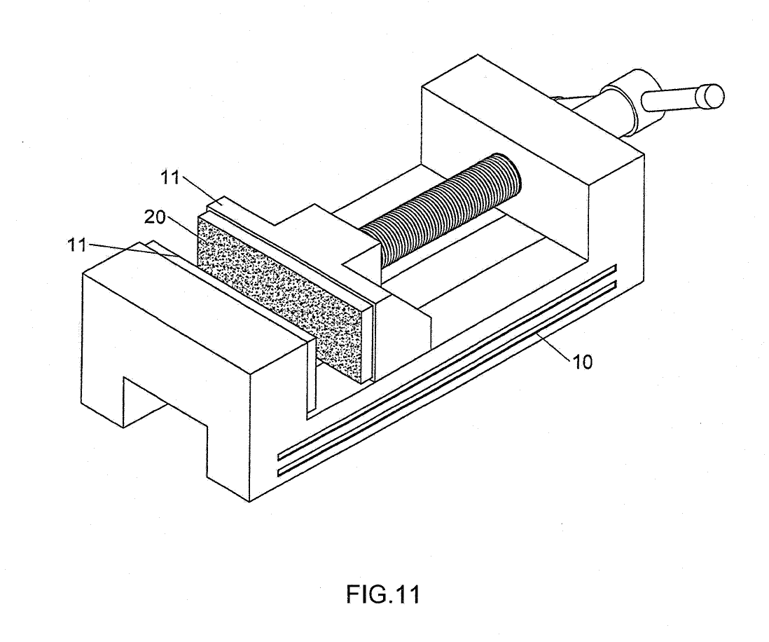

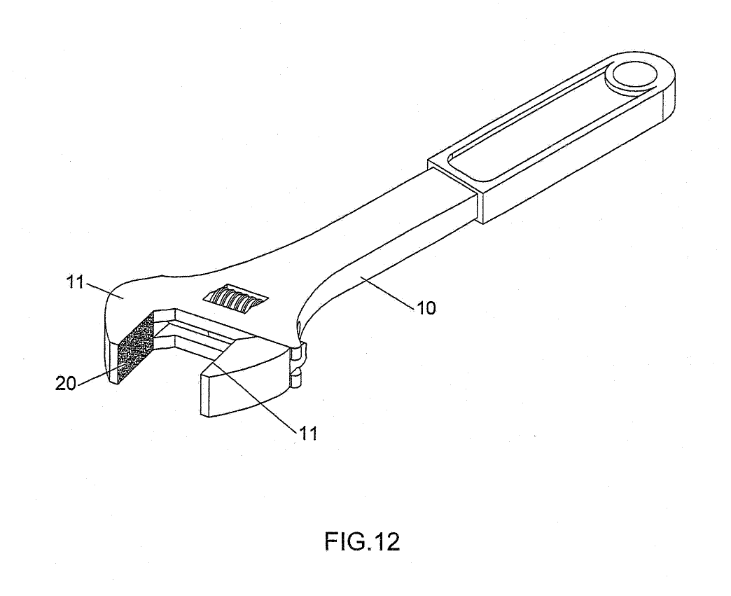

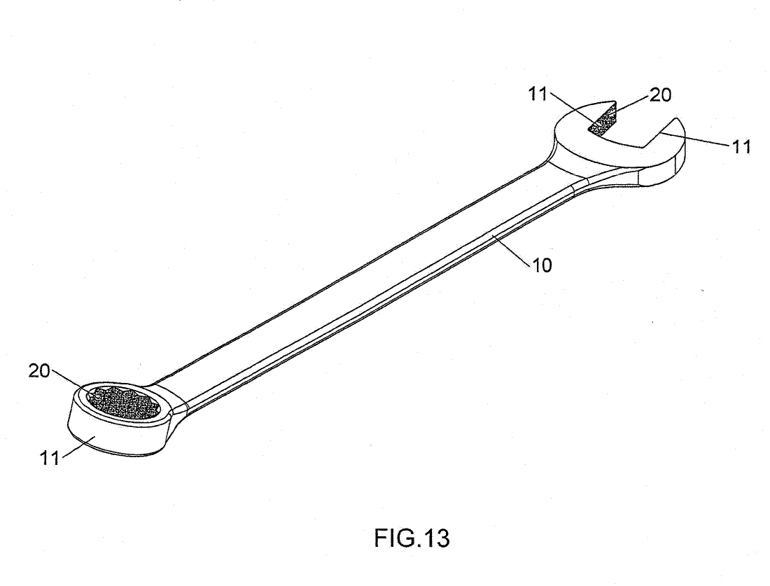

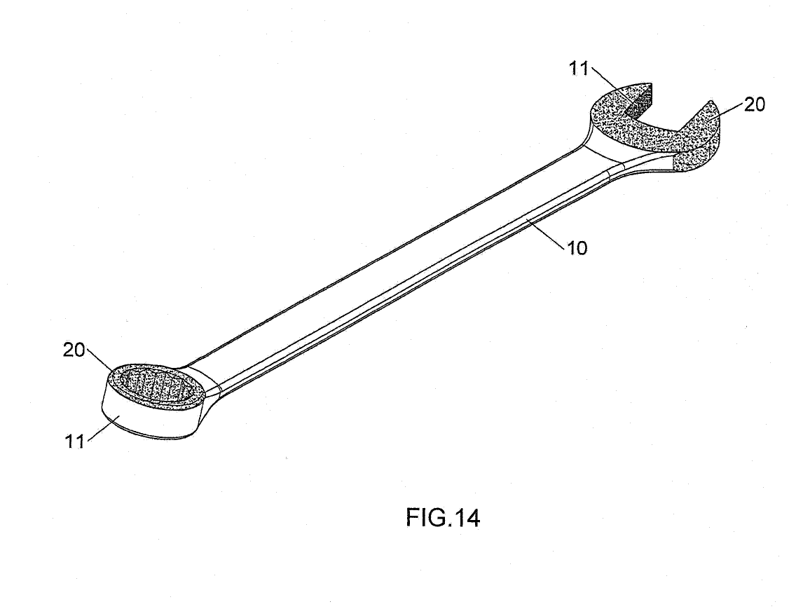

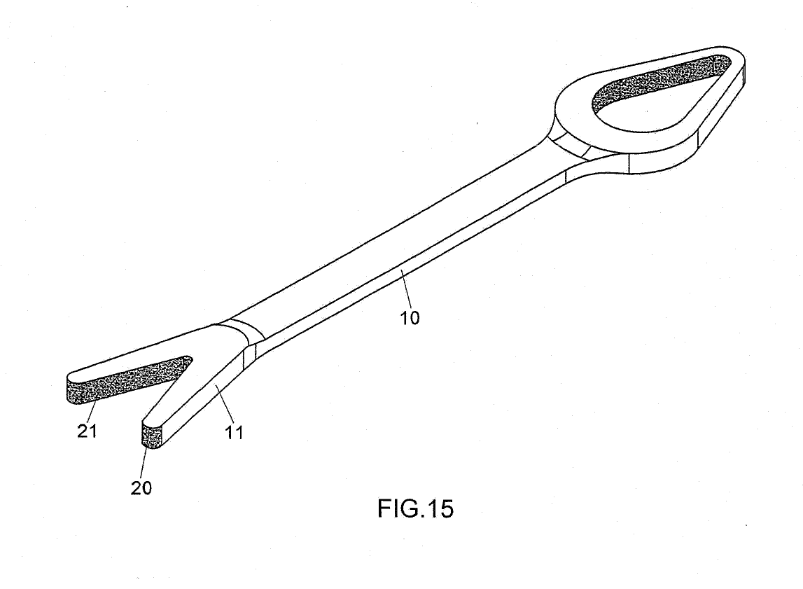

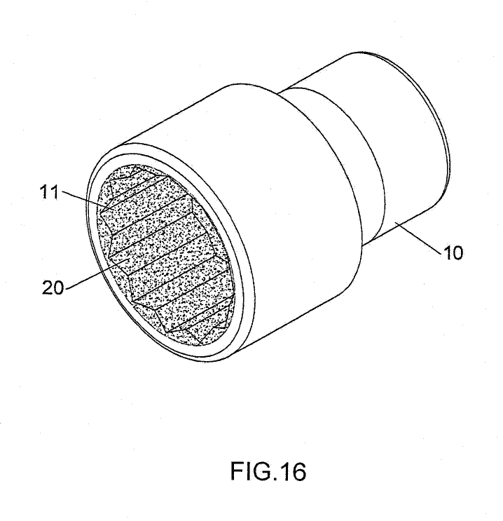

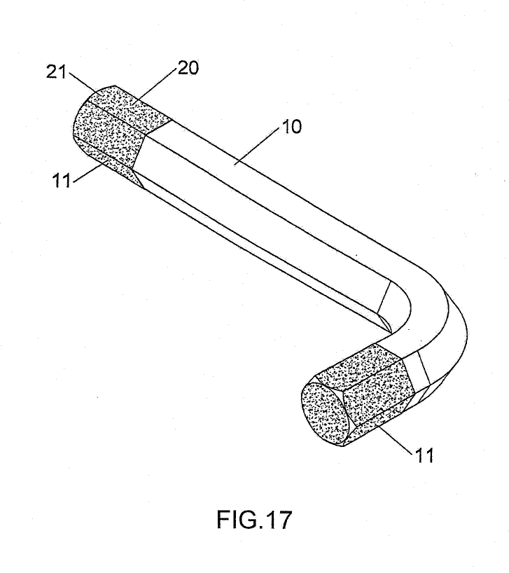

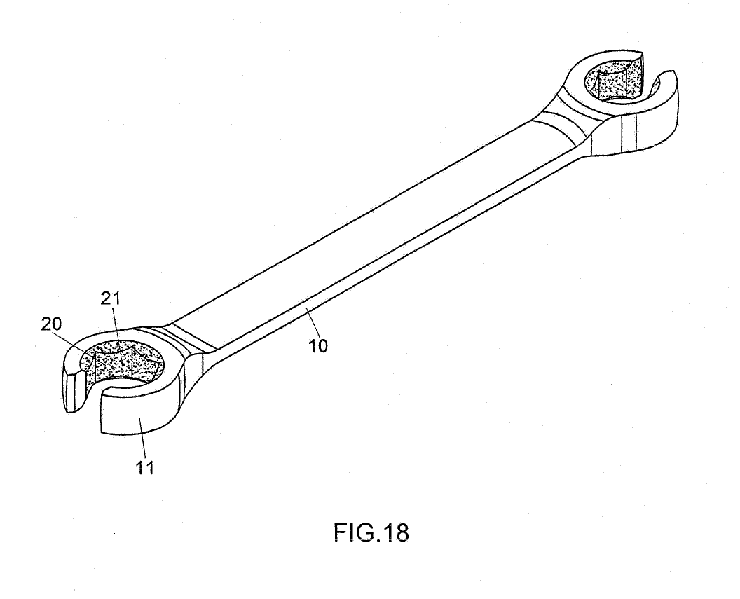

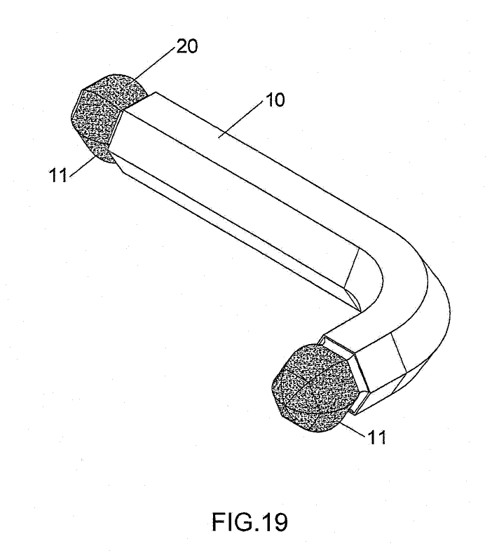

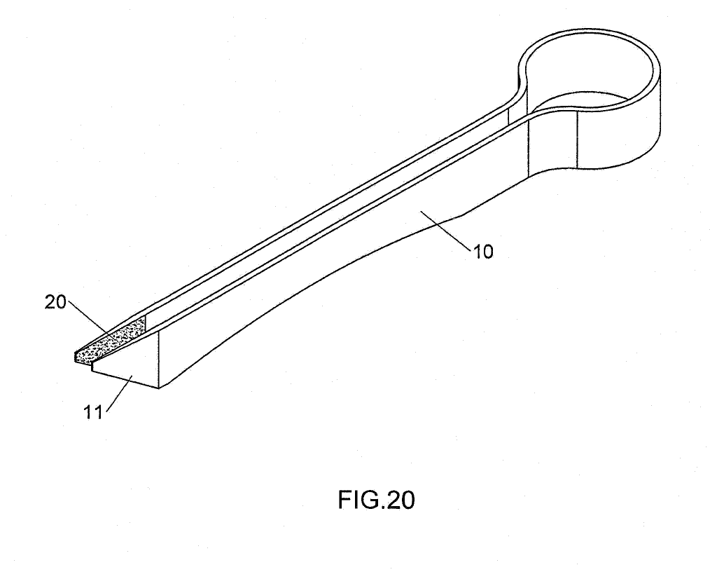

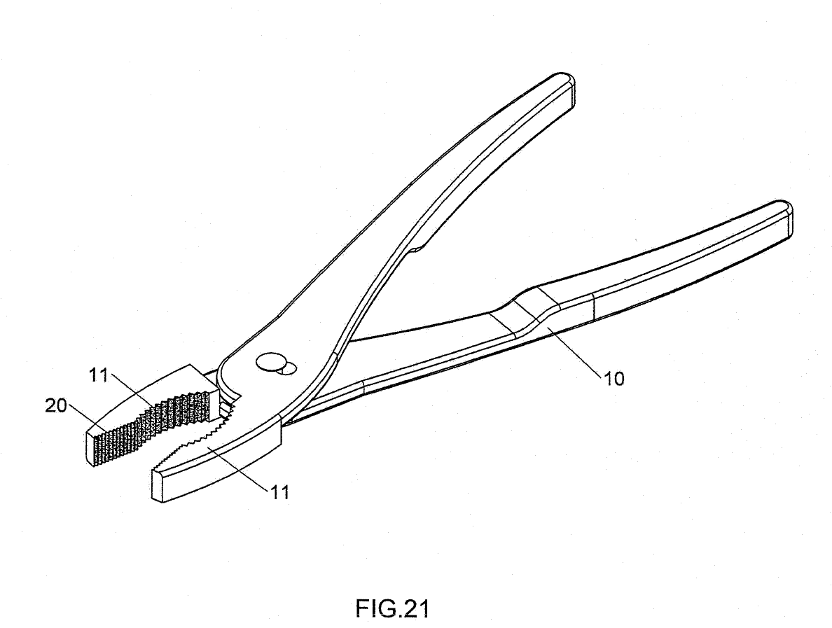

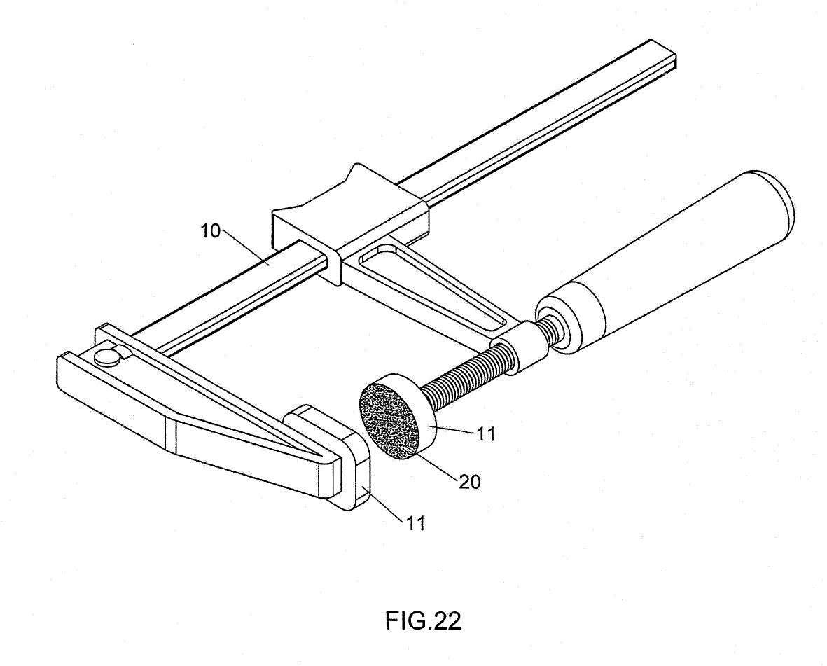

FIG. 11 shows the work tool 10 is the vise, FIG. 12 shows the work tool 10 is the adjustable pliers, FIG. 13 shows the work tool 10 is the wrench with an open end and a closed end, FIG. 14 shows the work tool 10 is the wrench with an open end and a closed end, wherein the abrasive particles 20 are spread to the function part 11 and the non-contact face adjacent the function part 11, FIG. 15 shows the work tool 10 is another wrench, FIG. 16 shows the work tool 10 is the socket with abrasive particles 20 on the inner surface thereof, FIG. 17 shows the work tool 10 is the Allen wrench with two function parts 11, FIG. 18 shows the work tool 10 is another wrench with two function parts 11 on two ends thereof, FIG. 19 shows the work tool 10 is another Allen wrench and each end has an universal joint, FIG. 20 shows the work tool 10 is the clip, FIG. 21 shows the work tool 10 is the diagonal pliers, and FIG. 22 shows the work tool 10 is the positioning/clamping tool.

When the contact face 12 of the function part 11 is a plane surface, the abrasive particles 20 increase the friction between the tool and the object, the teeth with the abrasive particles 20 increase further friction.

The abrasive particles 20 may also be used to trim edges of the objects. Even if the object or the tool is attached with oil or grease, the friction provided by the abrasive particles 20 ensure that the object can be held. The abrasive particles 20 may have different colors to help the users to verify the types of tools.

While we have shown and described the embodiment in accordance with the present invention, it should be clear to those skilled in the art that further embodiments may be made without departing from the scope of the present invention.

What is claimed is:

1. A work tool comprising:
a tool body and a function part connected to an end of the tool body 10, the function part having at least one contact face which is adapted to be in contact with an object, the at least one contact face having at least one area that has multiple abrasive particles, the abrasive particles forming a friction surface in the at least one area.

2. The work tool as claimed in claim 1, wherein the at least one contact face has multiple teeth.

3. The work tool as claimed in claim 2, wherein the friction surface is formed on each of the teeth.

4. The work tool as claimed in claim 1, wherein the abrasive particles are attached to the at least one contact face by way of electro-coating.

5. The work tool as claimed in claim 1, wherein the abrasive particles are combined with agent and formed onto the at least one contact face by way of sintering.

6. The work tool as claimed in claim 1, wherein a concentration of the abrasive particles on the at least one contact face is at least 20% g/cm³.

7. The work tool as claimed in claim 1, wherein the at least one contact face is a plane surface.

8. The work tool as claimed in claim 1, wherein the at least one contact face is fully attached by the particles.

9. The work tool as claimed in claim 1, wherein tool is one of a wrench, socket, clip and pliers.
